(19) United States
(12) Patent Application Publication
(10) Pub. No.: US 2015/0210018 A1
(43) Pub. Date: Jul. 30, 2015

(54) DEVICE AND METHOD FOR PRODUCING FIBER-REINFORCED PLASTICS COMPONENTS

(71) Applicants: Voith Patent GmbH, Heidenheim (DE); Audi AG, Ingolstadt (DE)

(72) Inventors: Markus-Thomas Lang, Munchen (DE); Michael Kaiser, Munchen (DE); Marco Göttinger, Munchen (DE); Sebastian Gierl, Augsburg (DE)

(73) Assignees: AUDI AG, Ingolstadt (DE); VOITH PATENT GMBH, Heidenheim (DE)

(21) Appl. No.: 14/597,271

(22) Filed: Jan. 15, 2015

Related U.S. Application Data
(63) Continuation of application No. PCT/EP2013/063778, filed on Jul. 1, 2013.

(30) Foreign Application Priority Data
Jul. 18, 2012 (DE) 10 2012 212 530.2

(51) Int. Cl. B29C 70/34; B29C 70/54

(52) U.S. Cl. CPC B29C 70/34; B29C 70/543

(57) ABSTRACT

A device and corresponding method for producing three-dimensional components from impregnated fiber tapes. The device includes a plurality of grippers, arranged alongside one another, for gripping fiber tapes impregnated with matrix material, the grippers can be displaced in a linear manner on mutually parallel paths between a pick-up position and a maximum position such that the fiber tapes can be tensioned between the grippers and respectively associated transfer devices; a rotatable table on which the fiber tapes can be laid in a first and at least one additional layer; a severing device which can sever the fiber tapes close to the transfer device; a heating device for heating the layers to 160° C. to 400° C.; a first molding tool and one or more additional molding tools which can be moved together to three-dimensionally form the layers; and a transporting device which can transport the heated layers between the molding tools.

### CROSS REFERENCE TO RELATED APPLICATIONS

This is a continuation of PCT application No. PCT/EP2013/063778, entitled “DEVICE AND METHOD FOR PRODUCING FIBRE-REINFORCED PLASTICS COMPONENTS”, filed Jul. 1, 2013, which is incorporated herein by reference.

### BACKGROUND OF THE INVENTION

1. Field of the Invention

The invention relates to a device and a method for producing fiber-reinforced three-dimensional components from thermoplastic, fiber-reinforced material, starting with impregnated fiber tapes.

2. Description of the Related Art

Fiber-reinforced plastic components feature a structure of reinforcing fibers which are embedded into a plastic matrix material. For more complex and high quality components, a multi-layer fiber structure having a load optimized fiber orientation is necessary. Impregnated thermoplastic fiber tapes are used as base material for the aforementioned production. Such fiber tapes consist of a single-layer, tape-type fiber base structure which is already impregnated with the required matrix material. These fiber tapes are available, for example, in roll form. One possible production method of such impregnated fiber tapes is described in DE 42 18 434 A1.

It is known to produce multi-layer rectangular sheets which serve as raw stock for further processing. US 2011/0111168 A1 describes how multi-axial flat sheets up to 2 m wide and which have good formability in the longitudinal direction, as well as directionally dependent strength, can be manufactured from such fiber tapes and which can be stored and further processed at a later date. One disadvantage in processing of these sheets is that considerable waste of expensive raw material occurs if more complexly shaped components are produced.

Alternatively, as described in DE 100 12 378 A1, the impregnated fiber tape can be placed directly onto a mold with the assistance of a so-called tape placement device. The fiber tape is heated during placement so that it can combine with the other tapes. In order to facilitate discretional component shapes and fiber layers in accordance with specific requirements, multi-axial gantry systems or articulated robots are utilized. Control of these movement systems is very complicated, relatively slow, and provides low placement rates in kg/h.

It is the objective of the current invention to provide a device and a method for the aforementioned production which is more cost effective, provides optimum material usage and which can be more effectively automated and is suitable for batch production of complex three-dimensional components.

### SUMMARY OF THE INVENTION

The objective in regard to the device is met in that the device includes:
a plurality of grippers, arranged alongside one another, for gripping fiber tapes impregnated with matrix material. The grippers can be moved linearly on mutually parallel paths, in each case between a pick-up position and a maximum position such that the fiber tapes can be tentered between the grippers and respectively associated transfer devices;
a rotatable table onto which the fiber tapes can be placed in a first layer and at least in one additional layer;
a severing device which can separate the fiber tapes near the transfer device;
a heating device to heat the layers between 160° to 400° C.;
a first molding tool and one or several additional molding tools which can be moved together so that they can form the layers to be three-dimensional;
and one transport device which can transport the heated layers between the molding tools.

The design according to the present invention provides several advantages. By parallel use of several grippers, fiber tapes can be placed simultaneously over the entire component surface. Due to the parallel and linear movement, the device and its automation can be arranged considerably more simply than currently known tape placement devices. In its entirety, this proves to be faster, more cost-effective, and more flexible for changeover to different components which have to be manufactured. The device can comprise at least 10 or at least 20 grippers. Since the grippers can be moved independently of each other to different intermediate positions, the fiber tapes can be placed according to the subsequent component contour. This avoids unnecessary scrap of expensive raw material, which can occur when using rectangular raw stock. Due to the use of impregnated fiber tapes as source material, no subsequent impregnation of the multilayer fiber structures with the associated risk of incomplete penetration needs to occur and expensive pre-manufactured raw stock such as, for example, multilayered sheets can be dispensed with. Moreover, it is energy saving if heat which is necessary to combine the fiber tapes or, respectively, the layers is used at the same time for the three-dimensional reshaping wherein no intermediate storage of the layer bundle is provided for, but rather reshaping occurs immediately subsequently in that the heated layers are placed into the molding tool.

The produced three-dimensional components may already have the final shape, or they can be an intermediate product which is then reshaped again.

Fibers for the used fiber tapes can include carbon, glass or aramid fibers. Single-layer fiber tapes can be used and such tapes can be used wherein the fibers are predominantly or completely oriented in one direction, such as the longitudinal direction. Fiber tapes can also be used which have a laid or woven base structure. The matrix material which is applied as impregnation—for example in the form of films, drops, layers, yarns, powder or fiber sheathing—can be a thermoplastic material, such as PEEK, PPS or polyamide. The impregnated fiber tapes can be provided, for example, in roll form in several unwind positions.

The severing device can be, for example, in the embodiment of knives, circular knives, shears, lasers, ultrasonic blades or oscillating blades. Due to the separation, the table can be rotated between placement of the first and the subsequent layer. The rotatable table can be rotated by +/−30° to +/−90°. Therefore layers can be placed at different angles in order to be able to arrange the fiber tapes in a load optimized manner. In one embodiment, the table can be raised or lowered substantially perpendicular to the parallel paths of the grippers, so that the table can be moved into and out of the plane of the tentered fiber tapes. The table is lowered for stretching and raised for placement. An additional severing device may be provided on the side of the grippers. The grippers may alternatively also be designed to be raised or lowered.

The heating device can be an IR-heating device, a hot air furnace, or an induction or microwave heating device. It may also be equipped with heated plates which can be brought into contact with the layers. In addition, one or several molding tools can also be heated in order to enable effective reshaping and consolidation. It may also be advantageous to design one or more molding tools so that they can be cooled, so that the component can be cooled and solidified immediately after reshaping. The transfer devices may include clamping devices which can hold the front of the fiber tapes so that the grippers can pick these up in the pick-up position.

To produce complex component geometries, the manufacture of three-dimensionality can be implemented in a two-step process. First, the layers are placed over an already slightly three-dimensional blank mold on the table. Subsequently the three-dimensional reshaping occurs in order to produce the final component shape. An excessive distortion occurring in a single step can hereby be avoided which, especially in the case of strongly three-dimensional shapes, bears the risk of distortion or wrinkle formation.

So that the layers cannot move after being placed, it can be advantageous to provide a fixation device which can heat the fiber tapes in certain locations so that the layers are combined with each other at those locations. This can be accomplished, for example, with heated stamps, or otherwise through contact heat, through inductive heating, with hot air, with microwave heat or with local IR radiators. In the case of stamps, they may be arranged such that they can possibly press the layer onto the three-dimensional preform which is located on the table.

To make consolidation of the layers possible and to press out possibly present air, it can be advantageous to provide a press device, in particular combined with the heating device, which can press the layers together during or after the heating process. In the case of a flat layer bundle, the press device can include two flat plates which are pressed against each other, thus consolidating the layers. It may be arranged after the heating device or may be combined with the heating device in that, for example, the plates can be heated.

In order to be able to achieve good formability and consolidation, it can be advantageous if the heating device is designed so that the fiber tape layers are heated over a large area, in particular completely to 160° to 400° C. The thermoplastic matrix material can be heated to the melting temperature (depending on the specific thermoplastic material) in order to achieve uniform penetration.

In order to form the desired component contour as effectively as possible, the severing devices can be capable of severing the fiber tapes at each transfer device, if required at each gripper, even if these are positioned at different locations. The respective severing device may be equipped with several severing modules across the width, whereby the severing modules are mounted, for example, on the transfer device or on the gripper and can be moved with the same. The respective severing device may also be movable across the width and in the direction of the gripper movement.

So that the subsequent component contour can be formed as effectively as possible, it can be advantageous if the width of the grippers is between 10 and 300 mm, such as between 30 and 100 mm. Narrower widths cause increased mechanical complexity, for example, because many grippers are required; and on greater widths tensile forces become too great, or respectively the uniformity of the fiber tape tension becomes more difficult to ensure.

Especially suitable for the movement of the layer or respectively the layer bundle to the molding tools is a transporting device which includes a tentering frame to hold the heated layers. Since the layers become soft, pliable, and sticky after having been heated, it can be advantageous if the layer bundle is held all around the edges. In the case of an already three-dimensionally placed and therefore preformed layer bundle, a wire mesh can be used alternatively or in addition as a support, or a hood. The transport device may moreover include a pivoting arm or a conveying device such as, for example, lateral belts, chains or towing ropes with which the tentering frame or the clamps or the wire mesh are transported. The transport device transports the heated layers at least from the heating device to the molding tools. It may however also assume the transport from the table to the heating device. Alternatively, a separate transport device could be provided for this.

If the transfer devices can be moved parallel to each other and independent from each other into different positions in the direction of the molding tools, a contour according to the desired component geometry can also be placed on this side, thus operating in a material-saving manner in conjunction with the respective severing device.

For the method the objective is met according to the invention in that the following steps are implemented successively, in particular when using one of the devices described above:
a) gripping several fiber tapes which are impregnated with matrix material using multiple grippers which are arranged adjacent to each other at the respectively allocated transfer devices;
b) tentering of the fiber tapes between the grippers and the respective transfer devices by linear parallel movement of the grippers;
c) placing of fiber tapes in one layer onto a rotatable table;
d) severing the fiber tapes at the transfer devices;
e) repeating steps a)-d) so that an additional layer of parallel positioned fiber tapes which are impregnated with matrix material is placed;
f) heating of layers to between 160° to 400° C. and
g) forming of the heated layers into a three-dimensional component with the assistance of a first molding tool and one or several additional molding tools.

The advantages that were discussed for the device according to the invention exist analogously for the method. It is positive for energy requirement if additional heating past 160° to 400° C. is avoided. This is the case with the inventive method through double utilization of the heat for the consolidation of the tapes and the layers, as well as for forming, in that the steps from the point of placement of the tapes to forming of the components occur chronologically closely together. The table can be lowered during tentering and, for the placement of the fiber tapes, the table can be raised into the tentering plane substantially perpendicular to the clamped fiber tapes.

For especially complex component shapes, for example with undercuts or a high degree of forming, the placement of the fiber tape layers can occur over a slightly three-dimensional preform which is provided on the rotatable table. The forming in step g) then does not need to be as strong. This avoids the risk of distortion or wrinkle formation of fiber layers and thereby increases component strength.

In order to achieve fiber arrangements which are load optimized, step e) can be repeated one or several more times whereby the table is always rotated by between 30° and 90° before one or, respectively, before several steps e) so that at least one layer is deposited at a different angle. Overall this results in a layer bundle consisting of several layers with different angles of the fiber tapes and fiber direction. One example for a layer composition could be: 0°/0°/+45°/−45°/90°/−45°/+45°/0°/0°. However, only a few or individual fiber tapes can be placed in individual layers as reinforcement tapes.

To prevent slippage of the layers, it can be advantageous if, after placement of one or more layers or after placement of all layers, fixation occurs through heating in certain locations. The heating occurs hereby not in large areas but only locally in order to create individual fixation points.

In order to achieve optimum material characteristics it can be advantageous to press the fiber tapes during or after step f), that is heating, and before step g), that is forming. The layers are hereby consolidated and possibly present air is pressed out. On flatly placed layers this can be accomplished with the assistance of two plates which are pressed against each other.

In order to increase the formability for forming in step g) and in order to be able to achieve good consolidation, the layers in step f) can be heated over a large region, in particular completely to between 160° to 400° C.

To further minimize waste, the grippers and the transfer devices can be moved in step b) or before step c) to different positions according to the subsequent component contour.

So that the fiber tapes can be placed more efficiently, in particular when using a three-dimensional preform on the table, the fiber tapes can be heated before placement to a temperature of between 80 to 260° C. The suitable temperature depends on the thermoplastic material, and is, for example, much higher for PEEK than polyamide. In each case it should be below the melting temperature, so that the plastic matrix becomes soft, but does not melt.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a first part of a device according to the invention for placement of layers on a table;

FIG. 2 is a perspective view of an embodiment of a second part of a device according to the invention for heating and forming of placed layers;

FIG. 3A is a schematic illustration of a step for placement of a first layer onto a rotatable table;

FIG. 3A1 is a schematic illustration of a step of fixation that can occur after the step illustrated in FIG. 3A;

FIG. 3B is a schematic illustration of a step for placement of a second layer on the first layer that is placed in FIG. 3A;

FIG. 3B1 is a schematic illustration of a step of fixation that can occur after the step illustrated in FIG. 3B;

FIG. 3C is a schematic illustration of a step of placement of a third layer on the first and second layers that are placed in FIGS. 3A and 3B;

FIG. 3C1 is a schematic illustration of a step of fixation that can occur after the step illustrated in FIG. 3C; and

FIG. 4 is another embodiment of a device according to the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

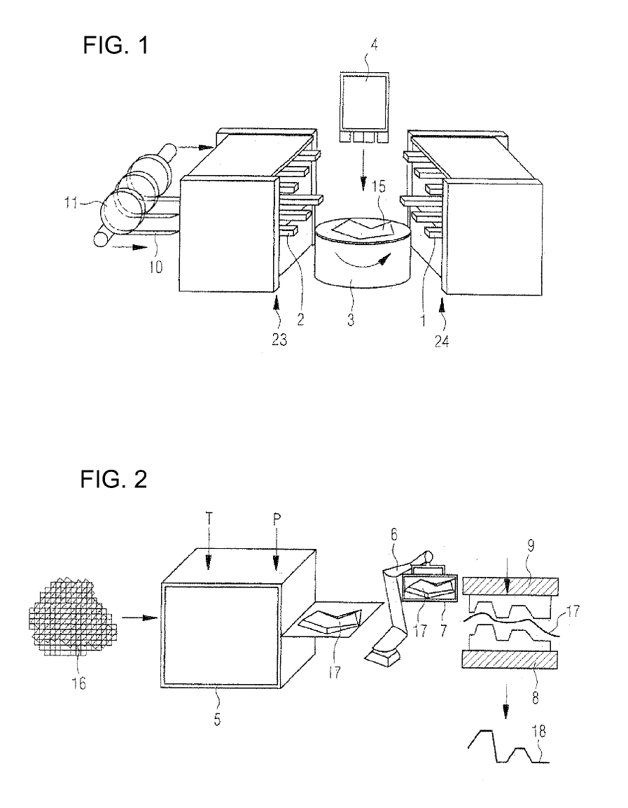

FIG. 1 illustrates an embodiment of the first part of a device according to the invention, after placement of one or more layers of fiber tapes. Impregnated fiber tapes 10 are guided from the unwind stations to transfer devices 2 which are arranged adjacent to one another. Grippers 1 are also arranged adjacent to one another and can be moved linearly and parallel to each other respectively between pick-up position 23 and maximum position 24. Grippers 1 grip the starting edge of fiber tapes 10 in the pick-up position and draw them over rotatable table 3. Grippers 1 move to an intermediate position according to the desired component contour. Transfer devices 2 which may, for example, be in the embodiment of clamping device are movable in order to come as close as possible to the component contour. The occurring waste can thereby be limited. Table 3 can then be raised so that the fiber tapes 10 are placed as a single layer.

By repeating the process, at least two layers are placed successively, thereby forming layer bundle 15 on table 3 consisting of the first layer and the one other or several additional layers. The severing unit, which is not illustrated, then severs the fiber tapes on the side of the transfer unit. An additional severing device may be provided on the side of grippers 1, or grippers 1 are opened thus releasing the fiber tape starting edges. Additional layers can be placed on the table 3 in the same manner. Due to rotating table 3, the individual layers can be deposited at various angles. This enables a load optimized and contour-true placement of the fiber tapes 10. After each, or only after individual layers, individual locations can be heated and thus fixed with the assistance of a fixation device 4 which can be a heating cartridge, IR-heating or induction heating device. Table 3 may also have a slightly three-dimensional preform over which layers 15 of fiber tapes are placed. Particularly with strongly three-dimensional components, the degree of subsequent forming is thereby reduced. This reduces the risk of distortion or wrinkle formation in the fiber structure. To improve placement, particularly when a three-dimensional preform is used on the table 3, fiber tapes 10 can be heated to a temperature of between 80 and 260° C. prior to being placed.

FIG. 2 illustrates an embodiment of the second part of a device according to the invention, showing the heating and forming process for a preformed layer bundle. At the same time, the invention may be implemented for a flat deposited layer bundle. Pre-formed layer bundle 16, in this example comprising the first and one or several additional layers, is transported to a treatment chamber 5 from the rotatable table 3 which is no longer illustrated here. In order to maintain the preform, it may be transported, for example, on an appropriate wire mesh which was located during placement between preform and the first layer. A heating device and press device are provided in the treatment chamber with which the layer bundle can be heated to 160 to 400° C. over a large area and is pressed at some locations. Heated, preformed layer bundle 17 comprising the first and the one or several additional layers is moved to between first molding tool 8 and second molding tool 9 by a transport device, shown as a pivoting arm 6 with a tentering frame 7. By closing first and second molding tools 8, 9, the preheated layer bundle 17 is formed three-dimensionally into the desired component shape. Component 18 is solidified after cooling. Molding tools 8, 9 can be heated or cooled, depending on whether additional heating for improved formability or cooling for stabilization of the shape is required.

In place of pivoting arm 6, a chain or towing rope can also be used. In place of tensioning or clamping frame 7, a wire mesh can also support the preformed heated layer bundle 17. Moreover, two separate treatment stations can be provided for heating by a heating device and for compression with a press unit. The sequence of compression and use of heating device is also exchangeable so that first the compression occurs, in particular if a fixing device is provided, and then the heating over a large area.

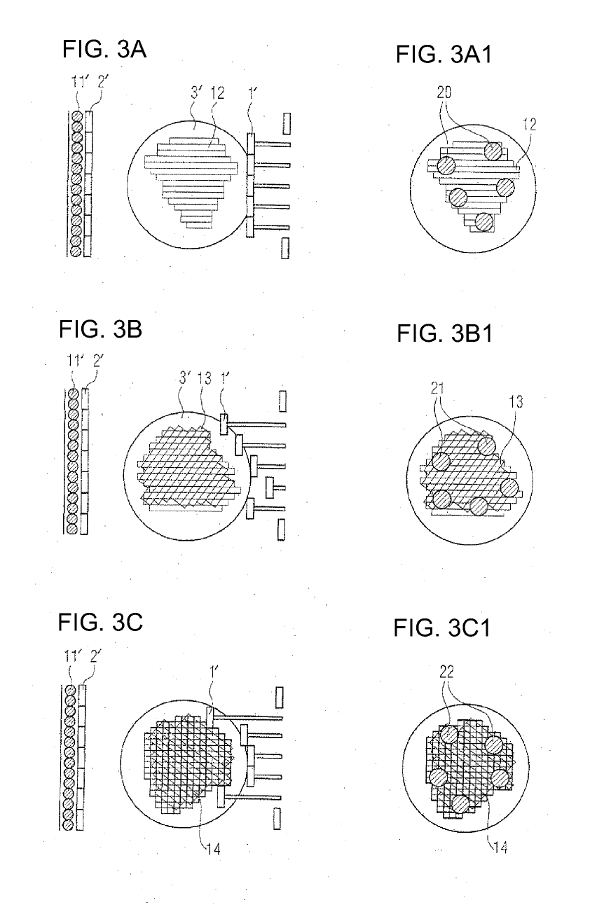

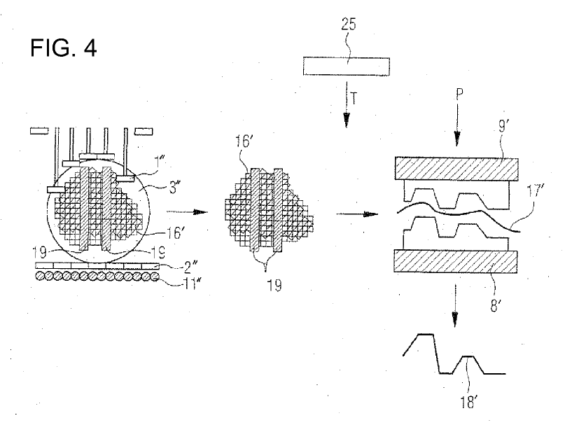

In order to illustrate placement of multiple layers, the steps are depicted sequentially in FIGS. 3A, 3B and 3C. FIG. 3A shows an embodiment of a device according to the invention after placement of first layer 12 of fiber tapes onto flat rotatable table 3′. Grippers l′ are already somewhat retracted and transfer devices 2′ are in the pick-up position. Unwind stations 11′ provide the impregnated fiber tapes. The step shown in FIG. 3A1 is optional. This shows how a fixation could be accomplished through local heating at certain fixing locations 20. Subsequently, the placement of an additional layer 13 onto first layer 12 occurs, as illustrated in FIG. 3B for example, at an angle of approximately 30° relative to the first layer 12. For this purpose, table 3′ was turned by the appropriate angle after placement of first layer 12. Fixation through heating at fixing locations 21 can also occur after second layer 13 is placed (as shown in FIG. 3B1). FIG. 3C illustrates placement of a third layer 14 onto other layers 12, 13. Table 3′ was also turned before in this case, for example, so that third layer 14 can be placed at approximately 60° relative to first layer 12. A fixation may also occur here subsequently to placing third layer 14 at fixing locations 22 (as shown in FIG. 3C1). Together, the layers form the layer bundle which is identified as 15 in FIG. 1 and which is then transported as preformed layer bundle 16 to be heated and the then heated layer bundle 17 is formed into component 18. In FIG. 4 the respective references are identified as 16′, 17′, 18′, etc.

Due to the fact that grippers 1′ and transfer devices 2′ can be moved to different locations, placement of the fiber tapes close to the contour of the desired component is possible, so that scrap can be minimized. The severing devices are not illustrated separately. The described device and the described method can be provided for flat placement onto table 3′ as well as for placement over a three-dimensional preform which is provided on table 3′. Fixation can occur using heated fixing stamps which press the fiber tape layer onto the preform.

The device illustrated in FIG. 4 is another embodiment of a device according to the present invention. Several layers of fiber tape are deposited onto a table 3″ on which a preform is located, so that a preformed layer bundle 16 is created. Also shown again are movable grippers 1″, transport devices 2″ which may also be movable and unwind stations 11″ for the provision of the impregnated fiber tapes. In this example, two individual reinforcement strips 19 are also placed. Layer bundle 16′ and reinforcement strips 19 are heated with a heating device 25 to a temperature between 160° to 400° C. Preheated layer bundle 17′ is then transported to between first molding tool 8′ and second molding tool 9′ and is formed three-dimensionally into the desired component shape by closing first and second molding tools 8′, 9′. The layer bundle 17′ can additionally be consolidated and air can be evacuated by utilizing an increased compression pressure during molding. Three-dimensional component 18′ solidifies as it cools. The cooling process can occur entirely or partially through contact with molding tools 8′or 9′.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION LIST

1, 1′, 1″ gripper
2, 2′, 2″ transfer devices
3, 3′, 3″ rotatable table
4 fixation device
5 treatment chamber with heating device and press device
6 swivel arm
7 tentering frame
8, 8′ first molding tool
9, 9′ second or additional molding tool
10 impregnated fiber tape
11, 11′, 11″ unwind stations
12 first placed layer
13 second placed layer
14 third placed layer
15 layer bundle, including the first and one or several additional layers, on the table
16, 16′ preformed layer bundle, including the first and one or several additional layers, before heating
17, 17′ preformed layer bundle, including the first and one or several additional layers, after heating
18, 18′ three-dimensional component, including the first and one or several additional layers
19 individual reinforcement strips
20, 21, 22 fixation locations
23 location of the pick-up positions
24 location of maximum positions
25 heating device

What is claimed is:

1. A device for producing fiber-reinforced three-dimensional components from thermoplastic, fiber-reinforced material, starting with impregnated fiber tapes, comprising:
a plurality of transfer devices;
a plurality of grippers arranged alongside one another for gripping fiber tapes impregnated with matrix material, said plurality of grippers being configured to move linearly on mutually parallel paths between a pick-up position and a maximum position such that fiber tapes can be tentered between at least one of said plurality of grippers and a respectively associated transfer device;
a rotatable table onto which the fiber tapes can be placed in a first layer and in at least one additional layer;
a severing device configured to separate the fiber tapes near at least one of said plurality of transfer devices;
a heating device configured to heat said layers to a temperature between 160° to 400° C.;
a first molding tool;
at least one additional molding tool configured to be moved together with said first molding tool to form said layers into a three-dimensional shape; and
a transport device configured to transport heated layers between said first molding tool and said at least one additional molding tool.

2. The device according to claim 1, wherein said rotatable table at least one of includes a three-dimensional pre-form over which said layers are placed and is configured to raise and lower substantially perpendicular to said parallel paths of said plurality of grippers.

3. The device according to claim 1, further comprising a fixation device configured to heat said fiber tapes in certain locations so that said layers can be combined with each other at said certain locations.

4. The device according to claim 1, further comprising a press device configured to press said layers together one of during and after heating said layers.

5. The device according to claim 4, wherein said press device is a part of said heating device.

6. The device according to claim 1, wherein at least one of said molding tools is configured to be one of heated and cooled.

7. The device according to claim 1, wherein said severing device one of includes a plurality of severing modules across a width of said entire device and is movable across said width and in a direction of movement of said plurality of grippers so that fiber tape can be severed at different positions at each of said plurality of transfer devices.

8. A method for producing fiber-reinforced three-dimensional components from thermoplastic, fiber-reinforced material, starting with impregnated fiber tapes, comprising the steps of:
gripping fiber tapes which are impregnated with matrix material using a plurality of grippers which are arranged adjacent to each other at respectively allocated transfer devices;
tentering said fiber tapes between said plurality of grippers and said respective transfer devices using linear parallel movement of said plurality of grippers;
placing said fiber tapes in a layer onto a rotatable table;
severing said fiber tapes near a location of said transfer devices;
placing at least one additional layer of parallel positioned fiber tapes which are impregnated with matrix material on said layer;
heating said layers to a temperature between 160° and 400° C.; and
forming said heated layers into a three-dimensional component using a first molding tool and at least one additional molding tool.

9. The method according to claim 8, wherein said placing said fiber tapes step occurs over a three-dimensional preform on said rotatable table.

10. The method according to claim 8, further comprising the step of rotating said rotatable table before said placing at least one additional layer step so that said at least one additional layer is deposited on said layer at a different angle.

11. The method according to claim 10, wherein said rotatable table is rotated by between 30° and 90°.

12. The method according to claim 8, further comprising the step of fixating layers following at least one of said placing steps, said fixating layers step including heating at least one layer in certain locations.

13. The method according to claim 12, wherein said fixating layers step occurs after all layers have been placed on said rotatable table.

14. The method according to claim 8, further comprising the step of pressing said placed layers.

15. The method according to claim 14, wherein said pressing step occurs concurrently with said heating step.

16. The method according to claim 14, wherein said heating step occurs over a large area of said placed layers.

17. The method according to claim 8, wherein at least one of a gripper and a transfer device are moved in one of said tentering step and before said placing said fiber tapes step to a different position according to a subsequent component contour.

18. The method according to claim 8, further comprising the step of heating said fiber tapes prior to placement on said rotatable table.

19. The method according to claim 18, wherein said fiber tapes are heated to a temperature between 80° and 260° C. during said heating said fiber tapes step.
